(19) United States
(12) Patent Application Publication
(10) Pub. No.: US 2019/0206278 A1
(43) Pub. Date: Jul. 4, 2019

(54) A SYSTEM AND METHOD FOR SPORTSMAN TRAINING

(71) Applicant: ISTANBUL SEHIR UNIVERSITESI, Sisli/Istanbul (TR)

(72) Inventors: Emrullah DELIBAS, Üsküdar/?stanbul (TR); Ali UZUN, Üsküdar/?stanbul (TR); Mehmet Fatih INAN, Üsküdar/?stanbul (TR); Onur GUZEY, Üsküdar/?stanbul (TR); Ali CAKMAK, Üsküdar/?stanbul (TR)

(73) Assignee: ISTANBUL SEHIR UNIVERSITESI, Sisli/Istanbul (TR)

(21) Appl. No.: 16/331,744

(22) PCT Filed: Dec. 16, 2016
(86) PCT No.: PCT/TR2016/050507

§ 371 Date: Mar. 8, 2019

(30) Foreign Application Priority Data
Sep. 8, 2016 (TR) 2016/12725

(51) Int. Cl. G09B 19/00; G09B 5/06

(52) U.S. Cl. CPC G09B 19/0038; G09B 5/06

(57) ABSTRACT

Analysis and training system accommodating a processor unit which can access a recorded positions database comprising the movement data like movement type of the movements like pass, shot realized by the players in at least one sports competition, dominant factors which are effective in realization of the movements, and the result of the movement, wherein a user equipment and that said processor unit is configured such that a model is formed where the dominant factors are correlated to each other in accordance with the result of the movement for any movement type by means of a statistical modeling method, such that the position information comprising the position information of the players and the time tag information when the players exist in this position is taken as input, such that an exemplary movement is applied to the model and such that the estimated result of the exemplary movement is transferred to said user equipment.

### TECHNICAL FIELD

The present invention relates to analysis of data of sports competitions. In more details, the present invention relates to an analysis and training system having a processor unit which can access a recorded positions database comprising movement data like the result of the movement and dominant factors which are effective in realization of the movements and the movement type of the movements like pass, shot, etc. realized by the players in at least one sport competition.

### PRIOR ART

Football teams essentially apply the tactics worked on pluralities of times beforehand in the trainings during a match. These tactics include items which are specific to the teams and also which are game parts learned by mutual experience within years and which are applied mutually by almost all teams. Therefore, football is a substantially predictable and systematic game. Thanks to its characteristic, football data is substantially convenient for analytic modeling and data mining applications. For instance, as a result of examination of various different competitions, complex play patterns can be calculated which are not visible at the first glance and which may be very valuable for the football coaches and footballers. By means of these patterns, the critical objects including the analysis of the team and the opponent team, suitable tactics and footballer selection and eliminating the disadvantageous aspects, which are prone to error and which are substantially vital and which are based on the personal capabilities and experiences of the football coach or the footballer together with the suitable measures developed together, can be realized with much less error in a manner supported by data analytics and data mining.

In such a frame, the data analytics based detailed analyses are delimited with simple statistics (for instance, number of shots on target) through the records kept manually until now. The most important reason of this is that the data acquisition technology which is realized in details required for complex analyses has not been substantially improved until now. In the recent years, thanks to the imaging and image processing technologies which monitor the players automatically and which record the positions of the players, the positions of the footballers and all important actions in the play are recorded in a database as raw data.

In the application GB2392036, a method and system for obtaining data relating to the performance of a participant in a sporting event held on a playing surface. The method comprises the steps of determining the position of the participant on the playing surface at different times from an indication of the location of the participant in a calibrated video image of the playing surface captured at different times.

In the present art, there are some computer-based tools which present the data, obtained by means of the above mentioned methods and similar methods, to the user. The main object in these tools is to present analytical data to the sportsman, coaches, sports interpreters and sportsman discoverers. The outputs of said tools can be the percent of shots on target at the end of a competition, the distance the sportsmen run and the visual presentation of the fields, where most of the important positions is realized, to the users. Thus, said data can be used for analysis during the competition and after the competition.

### BRIEF DESCRIPTION OF THE INVENTION

The present invention relates to an analysis and training system and method for bringing new advantages to the related technical field.

The main object of the present invention is to provide a training system and method which provides the sportsmen to be supported visually or aurally and which supports the sportsmen in selecting the movement they will make.

Another object of the present invention is to provide a training and analysis system which provides analysis of the positions and movements which have been realized or which are possible to be realized.

In order to realize all of the abovementioned objects and the objects which are to be deducted from the detailed description below, the present invention is an analysis and training system accommodating a processor unit which can access a recorded positions database comprising the movement data like movement type of the movements like pass, shot realized by the players in at least one sports competition, dominant factors which are effective in realization of the movements, and the result of the movement. Accordingly, the improvement of the present invention is that there is a user equipment and that said processor unit is configured such that a model is formed where the dominant factors are correlated to each other in accordance with the result of the movement for any movement type by means of a statistical modelling method, such that the exemplary movement data, comprising the digital data of the dominant factors which are effective in realization of the movement by means of the movement type between the players in the field by taking said position information into consideration, is applied to the model and such that the estimated result of the exemplary movement is transferred to said user equipment. Thus, the realization probability of a movement, which has not been realized yet, can be estimated by examining the prior data. Besides, after the movement is realized, instantaneous feedback related to the movement realized can be provided to the user.

In a preferred embodiment of the present invention, said user equipment comprises at least one image unit.

In another preferred embodiment of the present invention, said user equipment comprises at least one aural item.

In another preferred embodiment of the present invention, the processor unit is configured in a manner updating the formed models at a predetermined frequency.

In another preferred embodiment of the present invention, the input unit is a processor which can access an instantaneous position database where an image processing unit records said data where said image processing unit determines the position of the user in these images by means of image processing methods for the images of the user, positioned in a field, taken by means of pluralities of cameras, and configured in a manner defining at least one exemplary movement between the users by taking into consideration the instantaneous position information of the users inside the field.

In another preferred embodiment of the present invention, the processor unit is configured to access said instantaneous position database and to form the user interface in the image unit in accordance with the instantaneous position of the user. Thus, the movements which can be realized by the users/sportsmen in the positions thereof during the training and the success probabilities of these movements can be presented visually.

In another preferred embodiment of the present invention, the processor unit comprises an input interface where the user equipment can define a position and an exemplary movement on the user, and said input interface is connected to the input unit.

In another preferred embodiment of the present invention, said user equipment comprises a wireless communication interface and it is an augmented reality eyeglass.

The present invention moreover is a computer based analysis and training method where the field is monitored by the cameras in sports competitions and where these images are processed by the image processing unit and where the movements like pass, shot are defined with respect to the changes of the positions of the sportsmen inside the field, where the movement data like the type of movements, dominant factors which are effective in realization of the movements and the result of the movement are recorded in a recorded movements database in order to be analyzed, said analysis and training method is characterized by comprising the steps of forming a model by said processor unit where dominant factors are correlated to each other in accordance with the result of the movement for each movement type by means of a statistical modelling method; applying the exemplary movement data of an exemplary movement taken as input and comprising the digital data belonging to the dominant factors which are effective in realization of the movement by means of the movement type to said model; transferring the estimated result of the exemplary movement to a user equipment.

In another preferred embodiment of the present invention, the estimated result of the exemplary movement is displayed on the user equipment.

In another preferred embodiment of the present invention, the user is displayed by means of pluralities of cameras during the training,

the images, taken by an image processing unit, are processed by the image processing methods and the positions of the user and the items around the user are determined,
these positions are utilized and at least one exemplary movement is defined.

In another preferred embodiment of the present invention, at least one movement, which has a probability of success higher than a pre-selected ratio when applied onto the model, is transmitted to the user equipment put on by the user.

In another preferred embodiment of the present invention, a position and a movement are defined by the user by means of an input interface.

### BRIEF DESCRIPTION OF THE FIGURES

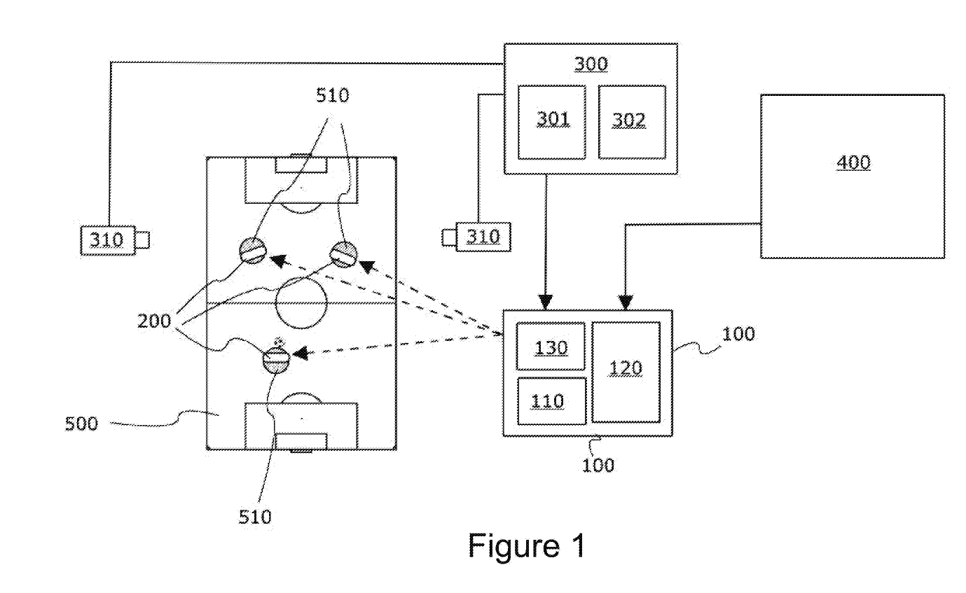

In FIG. 1, a representative view of an embodiment of the training and analysis system is given.

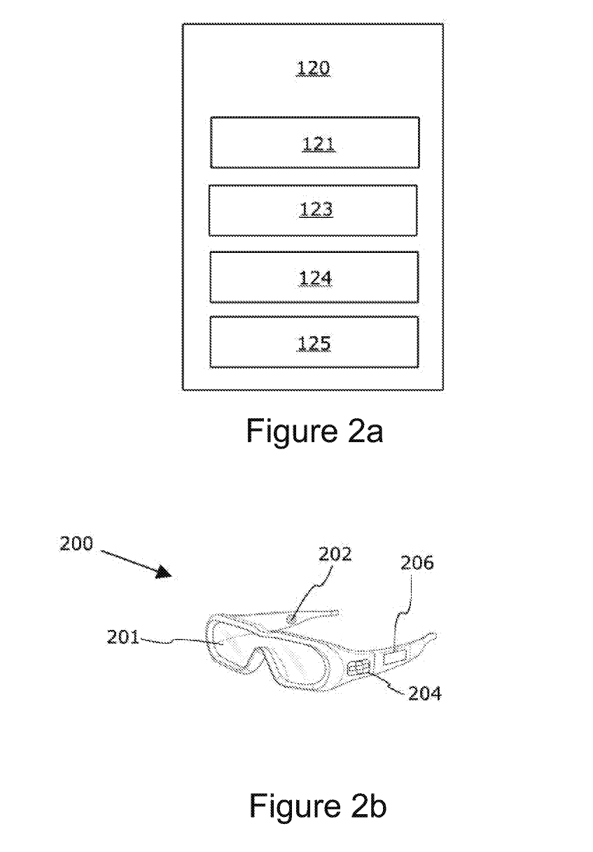

In FIG. 2a, a representative view of the processor unit is given.

In FIG. 2b, a representative view of the user equipment is given.

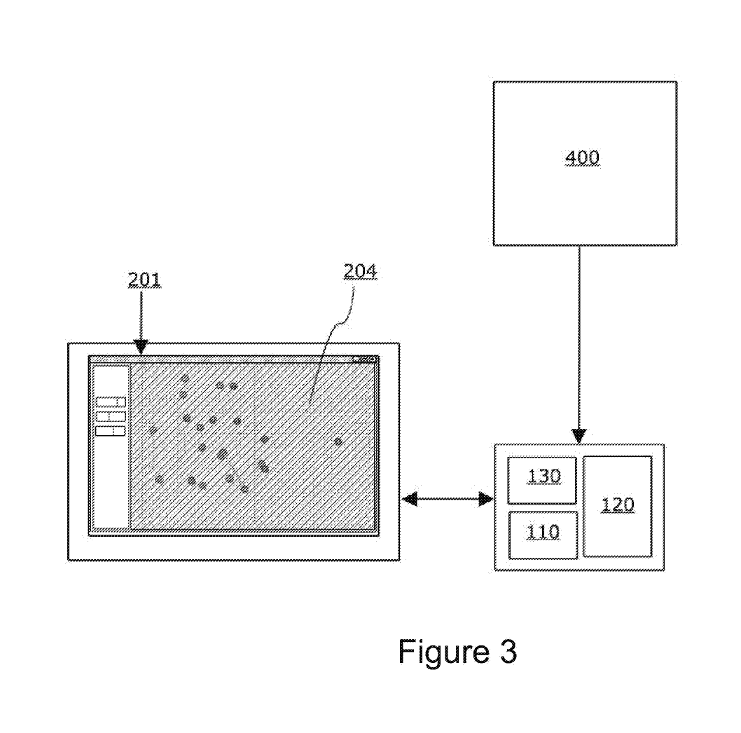

In FIG. 3, a representative view of another embodiment of the training and analysis system is given.

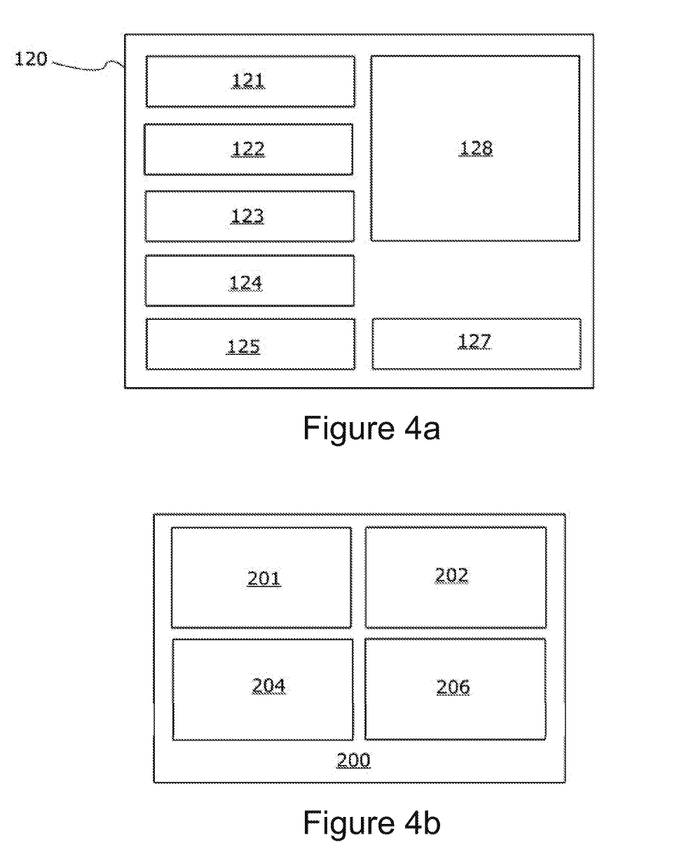

In FIG. 4a, a representative view of the processor unit is given.

In FIG. 4b, a representative view of the user equipment is given.

### REFERENCE NUMBERS

100 Estimation system
   110 Processor unit
   120 Memory unit
      121 Model determination module
      122 Position creation module
      123 Model application module
      124 Recommendation module
      125 User interface module
      127 Clustering module
      128 Sportsman database
   130 Communication interface
200 User equipment
   201 Image unit
   202 Aural item
   204 Input interface
   206 Wireless communication interface
300 Instantaneous position data source
   301 Image processing unit
   302 Instantaneous position database
310 Camera
400 Recorded positions database
500 Field
510 User

### DETAILED DESCRIPTION OF THE INVENTION

In this detailed description, the subject matter training system is explained with references to examples without forming any restrictive effect only in order to make the subject more understandable.

The present invention is essentially an analysis and training system where a processor unit (110), which can access a recorded positions database (400) comprising the data related to the activities of the sportsmen in the field (500) and obtained by means of processing these images by means of taking the images through pluralities of cameras (310) for the competitions played beforehand, forms a model through machine learning by utilizing the parameters which play role in the success ratios of specific movements (pass, shot, etc.) by utilizing this data; and where the data of an exemplary movement which may form after a position where the user (510) exists or where the data of an exemplary movement sent to the processor unit (110) as input is applied to said model and where the success probability of the exemplary movement is transferred to the user (510) visually and/or aurally through the user equipment (200). In the below mentioned exemplary embodiments, the sport, to which the system is applied, is football.

With reference to FIG. 1, in the first exemplary embodiment, there is a processor unit (110), a communication interface (130) and a memory unit (120). The processor unit (110) can be any general purpose or special purpose processor. The memory unit (120) may comprise RAM, ROM, magnetic or optic hard disc or any data storage device combination which can be read by the computer. The communication interface (130) can be any network interface card or any other type of communication device which will provide access to the cabled/wireless network or device.

An instantaneous position data source (300) takes the images of the medium, where the user (510) exists, by means of cameras (310); and said instantaneous position data source (300) processes said images and it saves them in a first database. In this embodiment, the users (510) are equipped with the user equipment (200). The medium, where the user (510) exists, is defined as field (500) in this exemplary embodiment. Said field (500) can be any training field or competition field for the sport branch where this system is to be applied. The instantaneous position data source (301) comprises an image processing unit (301) where the received images are processed and where the received images are correlated with various parameters and transformed into digital data. Said image processing unit (301) can also be connected to a processor. Said digital data are recorded to said instantaneous position database (302) in a permanent or temporary manner.

The data, existing in the instantaneous database (302), can be user (510) coordinates related to a special identity number belonging to the user (510) and related to a time tag. Here, the user (510) is the player/sportsman equipped with the user equipment (200) and existing in the field (500).

The recorded positions database (400) comprises the positions related to the finished competitions and the data related to the movements defined by the sequential positions and the digital data obtained by means of the above mentioned system or by means of a similar instantaneous data source. As an example to said digital data, the data related to the plays finished during one league duration can be given. Said data may comprise pluralities of movements of the play like pass, shot, cross, ball stealing, saving and the digital values of the dominant factors providing realization of these movements. These dominant factors can be exemplified as follows: the passes realized in each match, the intensities of said passes, the origin position and the target position of said pass, the conditions of the player to whom pass is realized, the condition of the reaching of the passes to the target, the minute of the play when the pass is realized, the player to whom pass is realized and the player who realizes the pass, the positions of the players related to the pass, the movement vector of the pass, the foot of the player which realizes the pass, the speed of the player to whom pass is realized, the height of the ball with respect to the ground when the pass is realized by the player, and the foot preferred by the player to realize the pass. Besides, in these competitions, a special identity number can be given to each player, and thus, the data can also be obtained for the player-based performance analysis. Said estimation system (100) can access said recorded positions database (400).

With reference to FIG. 2, the user equipment (200) can comprise an image unit (201), an aural item (202) or a warning item (not illustrated in the figure). Said warning item can be an accessory which the user (510) can fix to his/her wrist in a separate manner from the user equipment (200) and which can warn the user by means of vibration when required. Said image unit (201) can be a screen, and the aural item (202) can be a loudspeaker or a headset. The user equipment (200) may comprise an AR eyeglass. AR (Augmented Reality) eyeglass is equipment where partially the virtual image is overlapped onto the real image as known in the related art and thus where the user (510) can view his/her environment in a modified manner.

The processor unit (110) of the estimation system (100) executes the functional modules formed by pluralities of command sets. Said modules are provided in the memory unit (120) in this embodiment.

A model determination module (121) accesses the recorded positions database (400) comprising the information like position, movement, etc. related to the finished competitions. Through the recorded positions database (400), it models the recorded data related to the movements like pass, shot, clear, cross, free shot, by means of data mining and machine learning. Said machine learning algorithms are methods known in the related art and used frequently. Accordingly, when a model is formed for the pass, this model can be a decision tree, and said decision tree can be branched for the location of the player to whom the pass is targeted, for the location of the player who realizes the pass, for the distance between the position where the pass is realized from the foot and the target position for instance for the intensity of the pass. As a result of this branching, the pass movement is modeled. Thus, when this model is applied to a pass, it may be estimated which branches of the model this pass will be positioned and as a result, the success probability of this pass may be estimated. This branching model has been given for a machine learning algorithm where an algorithm like random forest is used. In different machine learning algorithms, different types of modeling can be provided.

Said model determination module (121) updates the formed models at a pre-selected frequency.

A model application module (123) takes as input the instantaneous data comprising the position information coming from the instantaneous position data source (300), and it determines at least one of the movements which can be realized after this position, and it applies said movement onto a model. During movement determination, the dominant factors of an exemplary movement in accordance with the sequential positions are determined. Afterwards, these dominant factors are applied to a model in accordance with the movement type, and the success probability of the determined movement is taken as output in accordance with the model.

A recommendation module (124) is selected in a manner presenting at least one of the most probably successful ones of these movements to the user (510).

A user interface module (125) provides imaging of the dominant factor information and movement taken from the recommendation module (124) on the user equipment (200). In the present embodiment, the user interface module (125) presents the positions which the user (510) is about to realize or the positions which the user (510) is probable to realize and the realization probabilities of these positions or the warnings related to these probabilities in a visual and/or aural manner in the user equipment (200).

In a possible embodiment where the user equipment (200) is an AR eyeglass, with the help of markers placed at specific positions or players inside the field (500), when the user (510) realizes movement, the regions where the movements which are highly probable to become unsuccessful have a different color and the regions where the movements which are highly probable to become successful have a different color. The user interface module (125) can process the interface provided in the user equipment (200) such that for instance if the success probability of the pass which the user (510) realizes to a first player is substantially higher than the success probability of the pass which the user (510) realizes to a second player, the first player is in green color and the second player is in red color.

The user equipment (200) can be fixed to all players existing in the field (500), and the estimation system (100) can communicate with all equipment.

Thus, a user (sportsman) (510) equipped with the user equipment (200) can take visually and/or aurally the information of which of the movements can be successful and the success probability of said movements before the user (510) realizes a movement while making training. This provides the visual training of the user (510) such that the user (510) is guided to realize the movements which may be successful. In a possible embodiment, the user (510) can select which types of movements can be recommended by the estimation system (100). For instance, the user (510) can send commands through an input interface (204) such that only passes are recommended by the estimation system (100). In this case, the processor unit (110) defines only the possible passes among the positions coming from the instantaneous position data source (300) and the processor unit (110) applies them to the model accordingly.

In another exemplary embodiment of the present invention, with reference to FIG. 3, the estimation system (100) is configured in a manner communicating in a cabled/wireless manner again with user equipment (200). As in the prior embodiment, in this embodiment, there is a processor unit (110), a communication interface (130) and a memory unit (120). The estimation system (100) can access the recorded positions database (400). In this embodiment, the user equipment (200) can be a device like smart whiteboard, a tablet, a computer, a smart phone. Thus, the user equipment (200) may comprise an aural item (202), an image unit (201). The user equipment (200) moreover comprises an input interface (204). Said input interface (204) is an input embodiment where the user (510) can send data to the estimation system (100). Said input interface (204) can be a mouse, a keyboard, a touch screen, a key pad.

The user (510) in this exemplary embodiment is the trainer, the analyzer or the trainee.

In this exemplary embodiment, the memory unit (120) comprises a model determination module (121) in order to be executed by the processor unit (110). The model determination module (121) accesses the recorded positions database (400) comprising the information like position, movement, etc of the played competitions in the prior embodiment. Through the recorded positions database (400), the recorded data related to the pass, shot, clear, cross, free shot is modelled by means of data mining and machine learning. Said model determination module (121) updates the formed models at a pre-selected frequency.

The user interface module (125) provides sending data to the user equipment (200), forming a user interface in the image unit (201) for the user (510), presenting data to the interface and receiving the data from the input interface (204) of the user equipment (200). The user interface module (125) moreover provides the user (510) to realize change (change of the position of the ball by the players) on a position formed at the user interface by means of the position creation module (122) by entering through the input interface (204) by the user (510) or on a position taken from the recorded positions database (400), and moreover provides defining of a movement (pass, shot) within the position.

A model application module (123) determines the success probability of the movement by testing the movement, defined on the user interface by means of the input interface (204), on the formed model. This result is presented to the user (510) by the user interface module (125). Thus, the old data can be analyzed by the sportsmen or trainers, and besides new, imaginary positions and movements are formed and the success probabilities thereof can be analyzed.

A clustering module (127) clusters the sportsmen by using sportsman based analysis data in the recorded positions database (400). This clustering is realized in the form of sub-categories for instance attack, defense, midfield categories, and the average running distance, the number of contact to the ball, the average position coordinates, number of departures, number of fouls, number of assists, number of passes on target and not on target, number of goals, the distance taken with the ball, the number and duration of ball dribble, number of shots, number of inventions by means of lying, number of yellow and red cards, the number of fouls realized to the player, number of crosses made, number of interventions made to the ball by means of the head, number of ball steals.

Since the data required for realizing these clustering processes is provided in the recorded positions database (400), clustering can be realized by means of the mathematical methods (for instance, k-intermediate clustering algorithms) known in the related art. The clustering results can be presented as the sportsmen and categories matching with the sportsmen to the user (510) by the user interface module (125). The clustering module (127) can keep the sportsmen separated in the categories in a sportsman database (128) provided in the memory unit (120). Thus, a database is obtained where the persons who seek for sportsman can reach and where the sportsmen can be clustered. In more details, since search can be realized by means of the user interface module (125) in this database, sportsmen can be seen which exist in the similar category, the affordable sportsmen can be reached in a more efficient manner by taking the characteristics of the star sportsmen as reference.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

1. An analysis and training system accommodating a processor unit (110) which can access a recorded positions database (400) comprising the movement data like movement type of the movements like pass, shot realized by the players in at least one sports competition, dominant factors which are effective in realization of the movements, and the result of the movement, characterized in that there is a user equipment (200), said user equipment (200) comprises a wireless communication interface (206) and it is an augmented reality eyeglass and that:
said processor unit (110) is configured such that a model is formed where the dominant factors are correlated to each other in accordance with the result of the movement for any movement type by means of a statistical modelling method,
such that the position information comprising the position information of the players and the time tag information when the players exist in this position is taken as input,
such that at least one exemplary movement is determined that can be realized after said position,
such that said exemplary movement, comprising the digital data of the dominant factors which are effective in realization of the exemplary movement by means of the movement type between the players in the field (500) by taking said position information into consideration, is applied to the model and such that the estimated result of the exemplary movement is transferred to said user equipment (200),
such that said exemplary movements which the user (510) is about to realize or the movements which the user (510) is probable to realize and the realization probabilities of these movements or the warnings related to these probabilities are presented in a visual and/or aural manner in the user equipment (200).

2. An analysis and training system according to claim 1, wherein said user equipment (200) comprises at least one image unit (201).

3. An analysis and training system according to claim 1, wherein said user equipment (200) comprises at least one aural item (202).

4. An analysis and training system according to claim 1, wherein the processor unit (110) is configured in a manner updating the formed models at a predetermined frequency.

5. An analysis and training system according to claim 2, wherein the processor unit (110) is related to an instantaneous position data source (300) comprising an image processing (301) unit configured so as to determine the position of the user (510) in these images by means of the image processing methods for the images, taken by means of pluralities of cameras (310), of the user (510) equipped with the user equipment (200) and positioned inside a field (500), said instantaneous position data source (300) further comprising an instantaneous position database (302) where said image processing unit (301) records said data.

6. An analysis and training system according to claim 5, wherein the processor unit (110) is configured to access said instantaneous position database (302) and to form the user interface in the image unit (201) in accordance with the instantaneous position of the user (510).

7. An analysis and training system according to claim 6, wherein the user equipment (200) comprises an input interface (204) where the user (510) may define a position and an exemplary movement and said input interface (204) is connected to the input unit (340).

8. (canceled)

9. A computer based analysis and training method where the field (500) is monitored by the cameras (310) in sports competitions and where these images are processed by the image processing unit (301) and where the movements like pass, shot are defined with respect to the changes of the positions of the sportsmen inside the field (500),
where the movement data like the type of movements, dominant factors which are effective in realization of the movements and the result of the movement are recorded in a recorded movements database (400) in order to be analyzed,
said analysis and training method is characterized by comprising the steps of:
forming a model by said processor unit (110) where dominant factors are correlated to each other in accordance with the result of the movement for each movement type by means of a statistical modelling method,
applying the exemplary movement data of an exemplary movement taken as input and comprising the digital data belonging to the dominant factors which are effective in realization of the movement by means of the movement type to said model,
transferring the estimated result of the exemplary movement to a user equipment (200).

10. An analysis and training method according to claim 9, wherein the estimated result of the exemplary movement is displayed on the user equipment (200).

11. An analysis and training method according to claim 9, wherein the user (510) equipped with the user equipment (200) is displayed by means of pluralities of cameras (310) during the training,
the images, taken by an image processing unit (301), are processed by the image processing methods and the positions of the user (510) and the items around the user (510) are determined,
these positions are utilized and at least one exemplary movement is defined.

12. An analysis and training method according to claim 9, wherein at least one movement, which has a probability of success higher than a pre-selected ratio when applied onto the model, is transmitted to the user equipment (200) put on by the user (510).

13. An analysis and training method according to claim 9, wherein a position and a movement are defined by the user (510) by means of an input interface (204).

14. An analysis and training system according to claim 1, wherein processor unit (110) is configured to mark areas or players on the user equipment (200) display which exemplary movements can be realized in said areas or with said players, in a different color based exemplary movement' estimated result.
